(19) United States
(12) Patent Application Publication
(10) Pub. No.: US 2019/0081808 A1
(43) Pub. Date: Mar. 14, 2019

(54) Intellectual property management system for sharing a functional-screen view in a data network

(71) Applicant: Berggren Oy, Helsinki (FI)

(72) Inventors: Marjo Pihlajamäki, Helsinki (FI); Heikki Kinnunen, Helsinki (FI); Anna Backman, Helsinki (FI); Katriina Ropponen, Helsinki (FI)

(73) Assignee: Berggren Oy, Helsinki (FI)

(21) Appl. No.: 16/129,892

(22) Filed: Sep. 13, 2018

Related U.S. Application Data
(60) Provisional application No. 62/558,532, filed on Sep. 14, 2017.

(51) Int. Cl. H04L 12/18; G06F 3/14; G06Q 50/18; G06F 21/62; G06F 3/0481; G06F 3/0484

(52) U.S. Cl. CPC H04L 12/1822; G06F 3/1454; G06Q 50/184; G06F 2221/2141; G06F 3/04817; G06F 3/04842; G06F 21/6218

(57) ABSTRACT

The application relates to an intellectual property management system (100) for sharing a functional-screen view in a data network (102). The system comprises at least one server (110), which is configured to communicate with a main user (111) and at least one end user (112, 114) through the data network, to run a user interface of the system, to receive a user data concerning at least one selected end user (112, 114) from the main user, to create a user group comprising the at least one selected user, and to receive a functional-screen view data from the main user. In addition, the at least one server is configured to create the functional-screen view to be shared in the user group on the grounds of the functional-screen view data, to create a functional-screen view icon, which provides an access to the functional-screen view and which is shared on the user interface of each end user (112, 114) of the user group, to receive an access request through the functional-screen view icon from an end user of the user group, and to visually present the functional-screen view on the user interface of the end user of the user group. The main user is able to modify a content of the functional-screen view. A modification of the functional-screen view content of the main user is allowed to be saved whereupon an updated functional-screen view content comprises the modified functional-screen view content. A modification of the functional-screen view content of any end user (112, 114) of the user group is prevented to be saved. Any end user (112, 114) of the user group is able to access to the updated functional-screen view content through the functional-screen view icon.

### PRIORITY

This application claims priority of provisional US application No. 62/558,532, filed on 14 Sep. 2017 the content of which is incorporated herein by reference.

### TECHNICAL FIELD

The application relates generally to an intellectual property (IP) management system for sharing a functional-screen view in a data network.

### BACKGROUND

Computer-based IP management systems are well-known and various commercial software systems are available on the markets for this purpose.

Such software systems comprise solutions for managing IP portfolios of e.g. patents, utility models, trademarks, and industrial designs, and their applications in organizations. These software systems enable to control deadlines, renewals, and costs of IP rights in managed IP portfolios.

### SUMMARY

One object is to provide an IP management system for sharing a functional-screen view for selected users inside the system.

One object is fulfilled by an IP management system, server device, method, a computer program, and computer-readable medium according to the independent claims.

One embodiment is an IP management system for sharing a functional-screen view in a data network that comprises at least one server. The at least one server is configured to communicate with a main user and at least one end user through the data network and to run a user interface (UI) of the system. In addition, the at least one server is configured to receive a user data concerning at least one selected end user from the main user and to create a user group comprising the at least one selected user. In addition, the at least one server is configured to receive a functional-screen view data from the main user and to create the functional-screen view to be shared in the user group on the grounds of the functional-screen view data. In addition, the at least one server is configured to create a functional-screen view icon, which provides an access to the functional-screen view and which is shared on the UI of each end user of the user group. In addition, the at least one server is configured to receive an access request through the functional-screen view icon from an end user of the user group and to visually present the functional-screen view on the UI of the end user of the user group. The main user is able to modify a content of the functional-screen view. A modification of the functional-screen view content of the main user is allowed to be saved whereupon an updated functional-screen view content comprises the modified functional-screen view content. A modification of the functional-screen view content of any end user of the user group is prevented to be saved. Any end user of the user group is able to access to the updated functional-screen view content through the functional-screen view icon.

One embodiment is a server device for sharing a functional-screen view in the above-mentioned system through a data network. The server is configured to communicate, by a data transfer part, with a main user and at least one end user through the data network. In addition, the server is configured to run, by a processor part, a UI of the system. In addition, the server is configured to receive, by the data transfer part, a user data concerning at least one selected end user from the main user and to create, by the processor part, a user group comprising the at least one selected user. In addition, the server is configured to receive, by the data transfer part, a functional-screen view data from the main user and to create, by the processor part, the functional-screen view to be shared in the user group on the grounds of the functional-screen view data. In addition, the server is configured to create, by the processor part, a functional-screen view icon, which provides an access to the functional-screen view and which is shared on the UI of each end user of the user group. In addition, the server is configured to receive, by the data transfer part, an access request through the functional-screen view icon from an end user of the user group and to visually present, by the processor part, the functional-screen view on the UI of the end user of the user group.

One embodiment is a method for sharing a functional-screen view in the above-mentioned system. The method comprises the step of running, by a processor part of the at least one server, a UI of the system. In addition, the method comprises the steps of receiving, by a data transfer part of at least one server, a user data concerning at least one selected end user from a main user through a data network and creating, by the processor part, a user group comprising the at least one selected user. In addition, the method comprises the steps of receiving, by the data transfer part, a functional-screen view data from the main user through the data network and creating, by the processor part, the functional-screen view to be shared in the user group on the grounds of the functional-screen view data. In addition, the method comprises the step of creating, by the processor part, a functional-screen view icon, which provides an access to the functional-screen view and which is shared on the UI of each end user of the user group. In addition, the method comprises the steps of receiving, by the data transfer part, an access request through the functional-screen view icon from an end user of the user group through the data network and visually presenting, by the processor part, the functional-screen view on the UI of the end user of the user group.

One embodiment is a computer program (software) for sharing a functional-screen view in the above-mentioned system. The computer program comprises UI code for running, by a processor part of the at least one server, a UI of the system. In addition, the computer program comprises user reception code for receiving, by a data transfer part of at least one server, a user data concerning at least one selected end user from a main user through a data network and group creation code for creating, by the processor part, a user group comprising the at least one selected user. In addition, the computer program comprises data reception code for receiving, by the data transfer part, a functional-screen view data from the main user through the data network and view creation code for creating, by the processor part, the functional-screen view to be shared in the user group on the grounds of the functional-screen view data. In addition, the computer program comprises icon creation code for creating, by the processor part, a functional-screen view icon, which provides an access to the functional-screen view and which is shared on the UI of each end user of the user group. In addition, the computer program comprises request reception code for receiving, by the data transfer part, an access re-quest through the functional-screen view icon from an end user of the user group through the data network and presentation code for visually presenting, by the processor part, the functional-screen view on the UI of the end user of the user group.

One embodiment is a tangible non-volatile computer readable medium that comprises the above-mentioned computer program.

Further embodiments are disclosed in the dependent claims.

### BRIEF DESCRIPTION OF THE FIGURES

The exemplary embodiments are presented with reference to the following figures:

FIG. 1 presents an IP management system

FIG. 2 presents a UI screenshot from a creation of the user group

FIG. 3 presents a UI screenshot from a creation of the screen view and its MyGreip icon

FIG. 4 presents MyGreip icons on a UI of the end user

FIG. 5 presents an administration of MyGreip icons

FIG. 6 presents a shared screen view on the UI of the end user

FIG. 7 presents functional parts of an IP management server

### DETAILED DESCRIPTION OF THE FIGURES

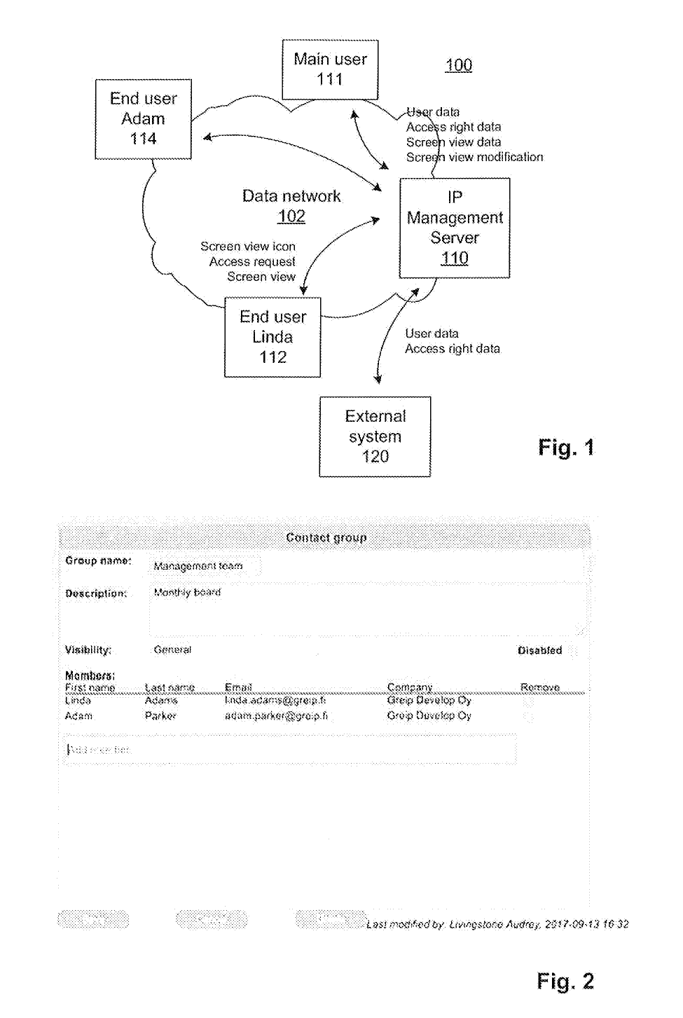

FIG. 1 presents an (Greip™) IP management system 100 that is used for sharing a functional-screen view through at least one data (telecommunications) network 102, e.g. one, two, or three networks.

The system 100 is used for managing IP portfolios of patents, utility models, trademarks, industrial designs, applications of such aforementioned IP rights, agreements, and drafts of such agreements. The system 100 enables control of e.g. deadlines, renewals, and costs of IP rights.

The functional-screen view can be e.g. a search result, report, summary, or work list.

The system 100 comprises at least one server device (computer) 110, e.g. one, two, or three servers. The server(s) 110 runs an IP management software 742 and controls a UI of the system.

In addition, the system 100 comprises at least one main user device (computer) 111, e.g. one, two, or three main users, and at least one end user device (computer) 112, 114, e.g. one, two, or three end users.

The server(s) 110, main user 111, and end user(s) 112, 114 are configured to communicate with each other through the data network 102, and the main and end users 111, 112, 114 use the UI of the system 100, which is controlled (run) by the server(s) 110.

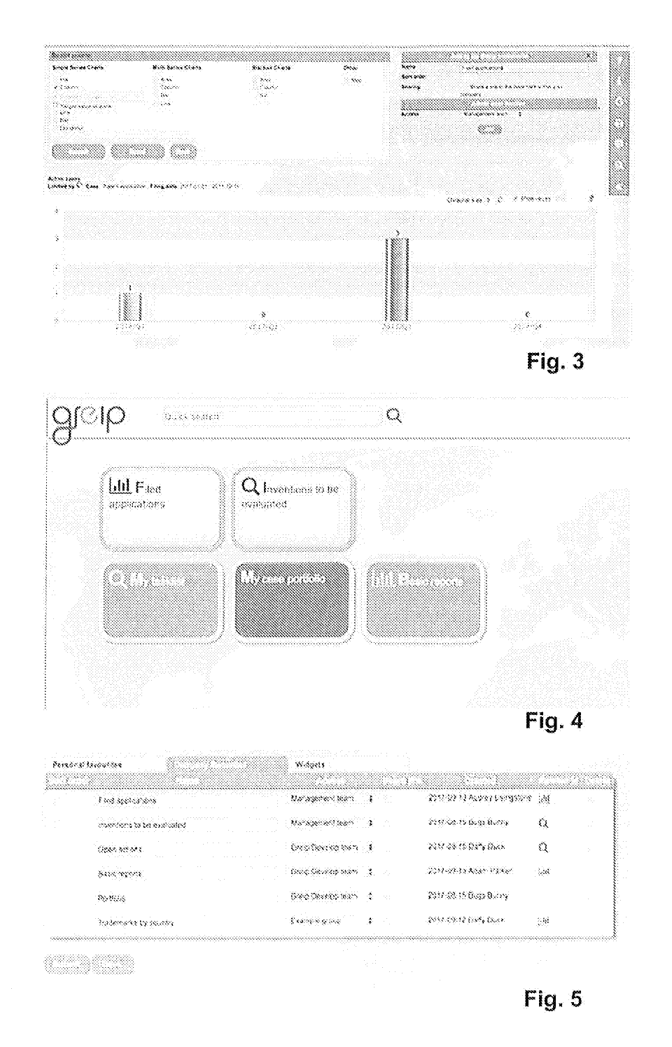

FIGS. 2 and 3 present screenshots from a UI of the main user 111 during a creation of a user group and a creation of a functional-screen view.

When the main user 111 wants to present some functional-screen view of the UI to some group of end users 112, 114, the main user 111 creates the user group. In this example, the user group is called “Management team”.

The main user 111 sends a user data to the server(s) 110. The user data indicates at least one end user 112, 114 who should be a part of the user group.

The server(s) 110 creates the user group, which comprises the indicated end user(s) 112, 114. In this example, the user group “Management team” comprises Linda Adams as a first end user 112 and Adam Parker as a second end user 114.

Then, the main user 111 creates the functional-screen view, which, in this example, presents a bar-graph report that indicates filed applications during each quarter Q1, Q2, Q3, and Q4 of year 2017. The main user 111 then sends a created functional-screen view data to the server(s) 110.

The server(s) 110 receives the created functional-screen view data from the main user 111 after the main user 111 has input necessary data by means of the UI in order to enable the creation of the functional-screen view.

The server(s) 110 creates the functional-screen view to be shared in the user group “Management team” on the grounds of the screen view data, and saves (stores) it to a database of the system 100.

Then, the server(s) 110 creates a functional-screen view (MyGreip) icon called “Filed applications”, which provides an access to the screen view for each end user 112, 114 of the user group “Management team” on the grounds of an input received from the main user 111.

FIG. 4 presents how the created screen view icon “Filed applications” is shared on the UI of each end user 112, 114 of the user group “Management team” as a shortcut to the created bar-graph report of the filed applications.

The server(s) 110 saves the screen view icon on the UI of each end user 112, 114 of the user group. In this example, this end user's 112, i.e. Linda's, UI also displays other screen view icons called “Inventions to be evaluated” and “Basic reports” created by the main user 111, and two screen view icons called “My tasklist” and “My case portfolio”, which Linda has created by herself and saved to her computer 112, as shortcuts to Linda's own task list and case portfolio.

FIG. 5 presents a screenshot how created functional-screen view icons are administered on the UI of the main user 111.

The server(s) 110 presents an icon list of at least one created functional-screen view icon, which comprises the created screen view icon and a user group for each created screen view icon so that the main user 111 can manage and update, when necessary, each icon. In this example, the icon list comprises five created functional-screen view icons and the content of the functional-screen view icons “Filed applications” and “Inventions to be evaluated” are shared to the user group “Management team” to which Linda and Adam belong. The content of the functional-screen view icons “Open actions”, “Basic reports”, and “Portfolio” are shared to the user group “Greip Development team” and Linda is a member of this user group, because the shortcut, i.e. the functional-screen view icon, “Basic reports” is shared to her UI according to FIG. 4.

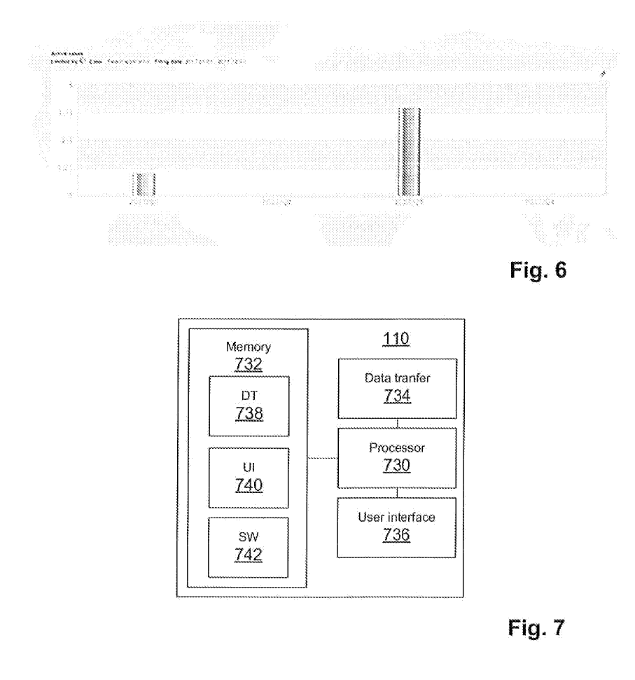

FIG. 6 presents what an end user 112, 114, i.e. Linda or Adam, see on her/his UI after using the shortcut, which the functional-screen view icon “Filed applications”, provides.

When this end user 112, 114 wants to see the content of the created screen view, she/he clicks the corresponding screen view icon, whereupon the server(s) 110 receives an access request and visually present the corresponding screen view on the UI of the end user 112, 114. In this example, it is displayed the bar-graph report that indicates filed applications during quarters Q1, Q2, Q3, and Q4.

The main user 111 is able to modify the content of the functional-screen view (report) and the modification of the screen view content is allowed to be saved, whereupon an updated screen view content (report) comprises the modified functional-screen view content.

The main user 111 is only user that can modify and save the shared screen view. The system 100 allows the end user 112, 114 to modify the content of the screen view, but it prevents to save the modification into this shared file.

In the future, the screen view icon provides the access to the updated screen view content to any end user 112, 114 of the user group.

In addition, the main user 111 is able to modify a content of the user group by adding an additional end user 112, 114 into the user group and/or by removing some end user 112, 114 from the user group.

In addition, each end user 112, 114 has an access right, which determines what she/he is able to see from the screen view. If her/his access right allows to see the content of the screen view completely, it is shown completely to him/her. Alternatively, if the (limited) access right allows to see only a part of the screen view, it is presented a limited screen view to him/her, where only an allowed parts are shown. In this example, Linda's screen view icon “My case portfolio” in FIG. 4 is a shortcut to the portfolio created by herself as previously mentioned or it may be a limited version of the content of the screen view icon “Portfolio”, where is displayed only IP cases managed by Linda as a member of the user group “Greip Development team” and other IP cases managed by other group member(s) are not shown to Linda because of her limited access right.

In addition, the server(s) 110 can receive the user data from an external system 120 through a communication interface of the system 100. The server(s) 110 can create the user group, and/or automatically add the additional end user 112, 114 into the user group and/or automatically remove the some end user 112, 114 from the user group, if some predetermined requirements are met, on the grounds an access right of the end user 112, 114.

FIG. 7 presents the functional parts of the IP management server 110 that is used in the system 100.

The server 110 comprises a processor part 730 in order to perform user and/or computer program (software) initiated instructions, and to process data. The processor part 730 can comprise at least one processor, e.g. one, two, or three processors.

In addition, the server 110 comprises a memory part 732 in order to store and to maintain data. The data can be instructions, computer programs, and data files. The memory part 732 can comprise at least one memory, e.g. one, two, or three memories.

In addition, the server 110 comprises a data transfer part 734 in order to send control commands and data to at least one of the main user 111, end user(s) 112, 114, and external system 120 through the network(s) 102. The data transfer part 374 also receives commands and data from at least one of the above-mentioned devices 111, 112, 114, 120 through the network(s) 102.

In addition, the server 110 comprises a UI part 736 in order to input control commands and data, to receive information and/or instructions, and to display information. The UI part 736 comprises at least one of a display, keyboard, touchscreen, touchpad, and mouse controller.

The memory part 732 comprises at least a data transfer application 738 in order to control the data transfer part 734, a UI application 740 in order to control the UI part 736, and a computer program (code, software) 742 in order to control the function of the server 100.

The memory part 732 and the computer program 742, with the processor part 730, can cause the server 110 at least to provide actions presented in context of the previous figures.

Such actions can be the communication, by means of the data transfer part 734, with the main user 111 and at least one end user 112, 114 through the data network 102 and the running (controlling) of the UI of the system 100.

In addition, such actions can be the reception of a user data that concerns the end user(s) 112, 114 from the main device 111 by means of the data transfer part 734 and the creation of the user group, which comprises the selected user(s) 112, 114.

In addition, such actions can be the reception of a functional-screen view data from the main user 111, by means of the data transfer part 734 and the creation of the functional-screen view to be shared in the user group on the grounds of the functional-screen view data.

In addition, such actions can be the creation of a functional-screen view icon, the reception of an access request through the functional-screen view icon from the end user 112, 114 of the user group by means of the data transfer part 734, and the visual presentation of the functional-screen view on the UI of the main and end user(s) 111, 112, 114.

In addition, such actions can be the saving of the functional-screen view content modified by the main user 111 and the visual presentation of the modified (updated) functional-screen view content on the UI of the main and end user(s) 111, 112, 114.

In addition, such actions can be the prevention of saving the functional-screen view content modified by any end user 112, 114 and the permitting an access to any end user 112, 114 of the user group to the updated functional-screen view content through the functional-screen view icon.

In addition, such actions can be the saving of the functional-screen view icon on the UI of the each end user 112, 114 of the user group and the presentation of the created functional-screen view icon list on the UI of e.g. the main user 111.

In addition, such action can be the permitting of the modification of the user group content by adding an additional end user 112, 114 into the user group and/or by removing some end user 112, 114 from the user group, and the visual presentation only a part of the functional-screen view content to the end user 112, 114 of the user group depending on the access right of this end user 112, 114.

In addition, such action can be the reception of the user data from the communication interface of the system 100, and the creation of the user group and/or the addition of a new end user 112, 114 into the user group and/or the removal of some end user 112, 114 from the user group on the grounds the access right of the end user 112, 114.

The computer program 742 can be a computer program product that comprises a tangible, non-volatile (non-transitory) computer-readable medium bearing a computer program code 742 embodied therein for use with a computer (server 110).

1. An intellectual property management system (100) for sharing a functional-screen view in a data network (102), comprising
at least one server (110), which is configured
to communicate with a main user (111) and at least one end user (112, 114) through the data network,
to run a user interface of the system,
to receive a user data concerning at least one selected end user (112, 114) from the main user,
to create a user group comprising the at least one selected user,
to receive a functional-screen view data from the main user,
to create the functional-screen view to be shared in the user group on the grounds of the functional-screen view data,
to create a functional-screen view icon, which provides an access to the functional-screen view and which is shared on the user interface of each end user of the user group,
to receive an access request through the functional-screen view icon from an end user of the user group, and
to visually present the functional-screen view on the user interface of the end user of the user group,
wherein the main user is able to modify a content of the functional-screen view,
wherein a modification of the functional-screen view content of the main user is allowed to be saved whereupon an updated functional-screen view content comprises the modified functional-screen view content,
wherein a modification of the functional-screen view content of any end user (112, 114) of the user group is prevented to be saved, and
wherein any end user (112, 114) of the user group is able to access to the updated functional-screen view content through the functional-screen view icon.

2. The system of claim 1, wherein the at least server is further configured to save the functional-screen view icon on the user interface of the each end user of the user group.

3. The system of claim 1, wherein the at least one server is further configured to present a list of at least one created functional-screen view icon, which comprises the created functional-screen view icon and a user group for each created functional-screen view icon.

4. The system of any of claim 1, wherein the main user is able to modify a content of the user group by adding an additional end user into the user group and/or by removing some end user from the user group.

5. The system of claim 1, wherein each of the at least one end user has an access right, which determines what an end user is able to see from the functional-screen view.

6. The system of claim 5, wherein the at least one server is configured to visually present only a part of the functional-screen view content to the end user of the user group depending on the access right of the end user.

7. The system of claim 1, wherein the at least one server is further configured to receive the user data from a communication interface of the system, and to create the user group and/or to add the additional end user into the user group and/or to remove the some end user from the user group on the grounds an access right of the end user.

8. A server device (110) for sharing a functional-screen view in an intellectual property management system (100) through a data network (102), configured
to communicate, by a data transfer part (734), with a main user (111) and at least one end user (112, 114) through the data network (102),
to run, by a processor part (730), a user interface of the system,
to receive, by the data transfer part, a user data concerning at least one selected end user (112, 114) from the main user,
to create, by the processor part, a user group comprising the at least one selected user,
to receive, by the data transfer part, a functional-screen view data from the main user,
to create, by the processor part, the functional-screen view to be shared in the user group on the grounds of the functional-screen view data,
to create, by the processor part, a functional-screen view icon, which provides an access to the functional-screen view and which is shared on the user interface of each end user of the user group,
to receive, by the data transfer part, an access request through the functional-screen view icon from an end user of the user group, and
to visually present, by the processor part, the functional-screen view on the user interface of the end user of the user group.

9. A method for sharing a functional-screen view in an intellectual property management system (100), comprising the steps of
running, by a processor part (730) of the at least one server, a user interface of the system,
receiving, by a data transfer part (734) of at least one server (110), a user data concerning at least one selected end user (112, 114) from a main user (111) through a data network (102),
creating, by the processor part, a user group comprising the at least one selected user,
receiving, by the data transfer part, a functional-screen view data from the the main user through the data network,
creating, by the processor part, the functional-screen view to be shared in the user group on the grounds of the functional-screen view data,
creating, by the processor part, a functional-screen view icon, which provides an access to the functional-screen view and which is shared on the user interface of each end user (112, 114) of the user group,
receiving, by the data transfer part, an access request through the functional-screen view icon from an end user of the user group through the data network, and
visually presenting, by the processor part, the functional-screen view on the user interface of the end user of the user group.

10. A computer program (742) for sharing a functional-screen view in an intellectual property management system (100), comprising
user interface code for running, by a processor part (730) of the at least one server, a user interface of the system,
user reception code for receiving, by a data transfer part (734) of at least one server (110), a user data concerning at least one selected end user (112, 114) from a main user (111) through a data network (102),
group creation code for creating, by the processor part, a user group comprising the at least one selected user,
data reception code for receiving, by the data transfer part, a functional-screen view data from the main user through the data network,
view creation code for creating, by the processor part, the functional-screen view to be shared in the user group on the grounds of the functional-screen view data,
icon creation code for creating, by the processor part, a functional-screen view icon, which provides an access to the functional-screen view and which is shared on the user interface of each end user (112, 114) of the user group,
request reception code for receiving, by the data transfer part, an access request through the functional-screen view icon from an end user of the user group through the data network, and
presentation code for visually presenting, by the processor part, the functional-screen view on the user interface of the end user of the user group.

11. A tangible non-volatile computer readable medium comprising the computer program (742) of claim 10.
